(19) United States
(12) Patent Application Publication
(10) Pub. No.: US 2026/0160689 A1
(43) Pub. Date: Jun. 11, 2026

(54) SHEARING INTERFEROMETRIC FLUORESCENCE TOMOGRAPHY FOR DEPTH-RESOLVED IMAGING

(71) Applicant: Vanderbilt University, Nashville, TN (US)

(72) Inventors: Yuankai Tao, Nashville, TN (US); Jet Rostykus, Nashville, TN (US)

(21) Appl. No.: 19/408,559

(22) Filed: Dec. 4, 2025

Related U.S. Application Data
(60) Provisional application No. 63/728,433, filed on Dec. 5, 2024.

(51) Int. Cl. G01N 21/64

(52) U.S. Cl. CPC G01N 21/6456; G01N 2021/6463

(57) ABSTRACT

Methods and apparatus for shearing interferometric fluorescence tomography. An example apparatus includes optics configured to collect fluorescence light emitted from a sample in response to an excitation optical beam. The apparatus also includes an interferometer configured to split the fluorescence light collected by the optics into a first light portion and a second light portion and further configured to recombine the first and second light portions with a shear therebetween. The apparatus also includes a grating configured to spectrally disperse the recombined light in wavelengths and a detector configured to capture the spectrally dispersed recombined light in a two-dimensional frame in which a first dimension represents the wavelengths and an orthogonal second dimension represents the shear.

### CROSS-REFERENCE TO RELATED APPLICATIONS

This application claims the benefit of U.S. Provisional Patent Application No. 63/728,433, filed 5 Dec. 2024, and entitled “Shearing Interferometric Fluorescence Tomography (SIFT) for Volumetric Imaging,” the contents of which are incorporated herein by reference.

### FIELD OF THE DISCLOSURE

Various examples relate generally to depth-resolved imaging and, more specifically but not exclusively, to spectrally resolved fluorescence-based imaging.

### BACKGROUND

Optical tomography is a form of computed tomography that is used to create a digital volumetric model of an object by reconstructing images from light transmitted through and/or scattered from an object. Applications of optical tomography include, but are not limited to, medical imaging, research, and quality control in semiconductor manufacturing.

Fluorescence tomography represents a modality of optical tomography configured for three-dimensional (3D) visualization of fluorescent probes within certain types of samples, such as biological tissues. Various fluorescence-tomography methods harness interactions of light with tissue, including absorption, scattering, and fluorescence, to reconstruct the spatial distribution of fluorescently labelled molecular targets. Ongoing refinements in optics, detector sensitivity, computational algorithms, and imaging approaches continue to beneficially broaden various clinical, preclinical, and research applications of fluorescence tomography.

### BRIEF SUMMARY OF SOME SPECIFIC EMBODIMENTS

Various examples provide methods and apparatus for shearing interferometric fluorescence tomography (SIFT) measurements in a single-objective imaging configuration that achieves full spectral-depth acquisition at each probed lateral position while maintaining compatibility with low numerical aperture (NA) objectives. In at least some examples, SIFT beneficially enables high-speed volumetric imaging without the use of mechanical scanning or pinholes, thereby providing certain advantages for at least some use cases, such as for in vivo retinal imaging.

In one example, an imaging apparatus comprises: optics configured to collect fluorescence light emitted from a sample in response to an excitation optical beam; an interferometer configured to split the fluorescence light collected by the optics into a first light portion and a second light portion and further configured to recombine the first and second light portions with a shear therebetween; a grating configured to spectrally disperse the recombined light in wavelengths; and a detector configured to capture the spectrally dispersed recombined light in a two-dimensional (2D) pixelated frame in which a first dimension represents the wavelengths and an orthogonal second dimension represents the shear.

In another example, an imaging method comprises: acquiring a plurality of two-dimensional (2D) pixelated frames representing self-interference of fluorescence light emitted from a sample in response to an excitation optical beam being scanned along a trajectory across the sample, with each one of the 2D pixelated frames corresponding to a different respective position of the excitation optical beam along the trajectory; based on each one of the 2D pixelated frames, obtaining a respective depth profile of the fluorescence light in the sample; and generating a volumetric image of the sample based on the respective depth profiles and further based on the trajectory, wherein a first dimension in the 2D pixelated frames represents wavelengths of the fluorescence light; and wherein an orthogonal second dimension in the 2D pixelated frames represents a shear used to produce the self-interference of the fluorescence light.

According to yet another example embodiment, provided is a non-transitory computer-readable medium storing instructions that, when executed by an electronic processor, cause the electronic processor to perform operations comprising the above method.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a schematic diagram illustrating the relationship between the fluorophore depth in the sample and the wavefront curvature according to an example.

FIGS. 2A-2B are schematic diagrams illustrating a shear-based method of quantifying the wavefront curvature according to some examples.

FIG. 3 is a schematic diagram illustrating a Sagnac interferometer configured to generate sheared optical beams according to some examples.

FIG. 4 is a schematic diagram illustrating an optical system used for shearing interferometric fluorescence tomography (SIFT) measurements according to some examples.

FIG. 5 pictorially illustrates an interference pattern captured using the optical system of FIG. 4 according to an example.

FIG. 6 is a schematic diagram illustrating an optical system used for SIFT measurements according to some additional examples.

FIG. 7 pictorially illustrates a frame captured by the detector of the optical system of FIG. 6 according to an example.

FIG. 8 is a flowchart illustrating a data-processing method used in the optical system of FIG. 6 according to some examples.

FIGS. 9A-9C pictorially illustrate various 2D frames generated during execution of the data-processing method of FIG. 8 according to some examples.

FIG. 10 is a block diagram illustrating a computing device one or more instance of which are used in the optical system of FIG. 6 according to some examples.

FIGS. 11A-11C pictorially and graphically illustrate volumetric imaging results obtained with the optical system of FIG. 6 according to an example.

### DETAILED DESCRIPTION

Fluorescent markers enable high-specificity imaging of cells and animal models, and advances in conjugation and transgenic technologies have allowed for a broader range of selectable targets for fluorescence-based imaging with improved imaging characteristics. For example, a combination of confocal gating with fluorescence microscopy tends to improve the utility of this imaging modality by enabling depth-sectioning. Rejection of out-of-focus light tends to improve resolution and supports volumetric visualization of Z-stacks and depth cross-sections.

Volumetric fluorescence imaging of in vivo retinal tissue has a significant potential in the development of regenerative therapies for retinal diseases by offering molecular specificity, dynamic imaging capabilities, and depth-resolved visualization. These features are important for identifying novel treatment pathways and assessing their efficacy and safety in vivo. Fluorescent imaging of live models enables longitudinal tracking of cellular behaviors and molecular pathways, and volumetric imaging extends this utility by recording retinal structure and function in three dimensions (via Z-stacks and cross-sectional views), thereby making it particularly well-suited for capturing subtle changes in tissue organization, cellular distribution, and functional architecture that may accompany disease progression or repair. The development of novel interventions, such as stem cell transplantation, gene therapies, and nanostructure delivery systems, benefits from the precision afforded by fluorescent imaging for monitoring therapeutic integration, adverse responses, and functional restoration. Better understanding of these functions in both mammalian and regenerative models can benefit from strategic use of fluorescent imaging techniques paired with transgenic reporter lines targeting cell types with important roles in retinal damage response and repair, e.g., including microglia, Muller glia, and ganglion cells.

Some state-of-the-art methods for volumetric fluorescence imaging may either suffer from significant performance limitations or be not compatible with in vivo retinal samples. For example, confocal microscopy utilizes a pinhole to improve contrast by rejecting out-of-focus light, but in in vivo retinal imaging it is limited to low lateral and axial resolution because the numerical aperture (NA) is constrained (e.g., to NA<0.05) due to imaging through the anterior segment of the intact eye. Scanning laser ophthalmoscopy (SLO) maintains a confocal gate, thereby allowing for depth tuning by mechanically shifting the sample or adjusting the microscope's focal distance. However, resolution may remain limited by the native aberrations of the eye. The addition of adaptive optics can improve the resolution, but the extent of such improvements is limited by a relatively small field of view. Light sheet microscopy (LSM) provides two-dimensional (2D) multiplexing, thereby making acquisitions significantly faster and offering intrinsic registration across the imaged plane. However, LSM relies on side illumination and relatively complex sample mounting, which does not appear to be feasible for in vivo retinal imaging. Oblique SLO (OSLO) utilizes a tilted illumination plane to work with a single objective. However, it may suffer from one or more of nonuniform point spread functions across the field, degraded intrinsic registration due to asymmetries between excitation and collection paths, and reduced fluorescence collection efficiency, since only part of the eye's aperture is used.

Interferometric approaches to depth sectioning may ostensibly provide a viable alternative to some of the above-indicated techniques. For example, the use of optical coherence tomography (OCT) significantly improved structural retinal imaging by performing volumetric acquisitions at low NA values and achieving higher speed and signal-to-noise ratio (SNR) through Fourier-domain multiplexing. Nevertheless, a significant limitation of OCT is that it is not suitable for detecting incoherent signals, such as those from fluorescent markers. Four-π fluorescence interference microscopes enable interferometric depth encoding for fluorescence imaging and may achieve sub-wavelength axial resolution via multi-phase interference in some use cases. However, such microscopes are configured to use dual-objective configurations with concomitant access to both sides of the sample, which renders them incompatible with in vivo retinal imaging.

At least some of the above-indicated problems in the state of the art can beneficially be addressed using various examples, aspects, features, and embodiments of shearing interferometric fluorescence tomography (SIFT) disclosed herein. In one example, SIFT utilizes self-interference of fluorescence emission wavefronts to axially localize fluorophores in depth. A corresponding system uses a shearing interferometer to encode deviations from planar wavefronts as spatial frequencies, thereby decoupling the axial resolution from the lateral resolution and substantially eliminating a need for pinhole apertures. The resulting interferometric signal is detected using a 2D spectrometer to concurrently measure the fluorescence spectra and wavefront curvature. The described depth-multiplexed approach includes substantially instant acquisition of the entire depth fluorescence profile at each excitation location. The corresponding sequence of frames can be processed, e.g., as described in more detail below, to obtain SIFT-based volumetric images of the field of view (FOV).

In some examples, depth multiplexing enables high-speed Z-stack imaging without a need for moving mechanical components or pinholes, with broad potential applications in in vitro and in vivo imaging in basic science and clinical diagnostics. The derived set of resolution and depth-sectioning relations can be used to guide further improvement and optimization of SIFT systems. Some examples provide a substantial improvement in axial resolution, e.g., from 1.6 mm to 1.0 mm with a relatively small increase in shear from 636 μm to 720 μm. This magnitude of improvement demonstrates the feasibility of obtaining an even higher axial resolution by further optimization of the SIFT system.

In some examples, SIFT leverages a Sagnac shear interferometer to detect self-interference of fluorescence emission wavefronts, encoding depth-dependent deviations from planar wavefronts as spatial frequencies. This feature of SIFT obviates the need for physical pinholes or depth scans, which enables faster scans and reduces the risk of photobleaching. Fluorescence signals are concurrently resolved in both spectrum and wavefront curvature using 2D detection. This feature beneficially yields volumetric and spectroscopic information in a single acquisition. In various examples, SIFT demonstrates the beneficial ability to perform volumetric spectroscopic fluorescence imaging in the retina using a single-objective, achieves full-depth acquisition per probed lateral position, and provides compatibility with low-NA objectives.

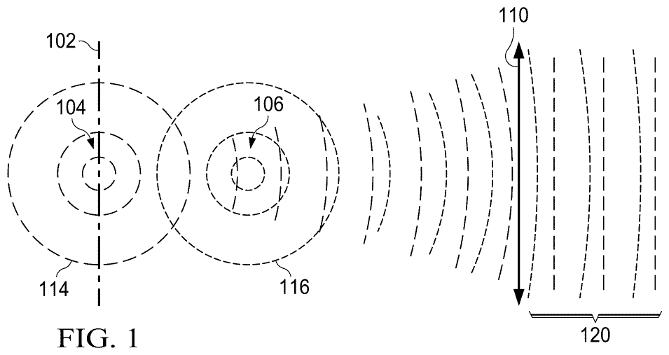

FIG. 1 is a schematic diagram illustrating the relationship between the fluorophore depth in the sample and the wavefront curvature according to one example. In the example shown, the depth is measured with respect to the plane of an objective lens 110. A first fluorophore 104 is located at a focal plane 102 of the objective lens 110. A second fluorophore 106 is located closer to the objective lens 110 than the first fluorophore 104. When exited, the fluorophores 104 and 106 stochastically emit respective incoherent spherical waves 114 and 116. When the spherical waves 114 and 116 pass through the aperture of the lens 110, the lens 110 will collimate the light originating from the first fluorophore 104 located at the focal plane 102 but will leave a residual curvature in the wavefronts for the off the plane sections of the sample exemplified by the second fluorophore 106. This difference in the wavefront curvature can be clearly seen in an area 120 located to the right of the objective lens 110 in FIG. 1. The shown example qualitatively illustrates that the fluorophore depth within the sample is encoded in the wavefront curvature of the light collected by the objective lens 110. Thus, given a capability for measuring the residual wavefront curvature, the corresponding imaging system will be able to perform depth sectioning of the sample.

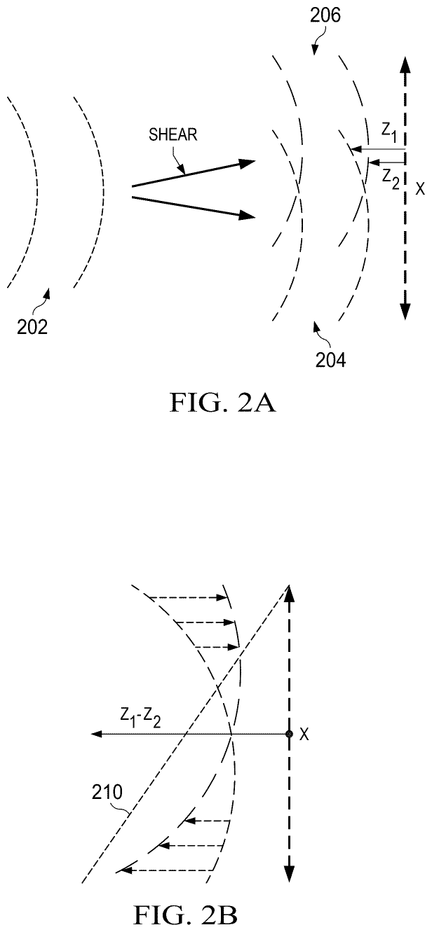

FIGS. 2A-2B are schematic diagrams illustrating a shear-based method of quantifying the wavefront curvature according to some examples. This method is substantially based on observing self-interference of an optical beam 202. The effect of self-interference is achieved by splitting the optical beam 202 into two partially separated, attenuated beam copies 204 and 206, e.g., as indicated in FIG. 2A. The beam copies 204, 206 will partially overlap when separated by a lateral distance that is smaller than the beam diameter. Herein below, this lateral separation is referred to as “shear” or “shear distance.”

FIG. 2B graphically illustrates that, when observed, the sheared beam copies 204 and 206 exhibit an approximately linear relative phase ramp along the lateral dimension X across their shared overlap, as exemplified by a sloped line 210. The slope of the line 210 depends on the wavefront curvature of the optical beam 202 and manifests itself in an interference pattern observed in the overlapped region. Due to being a manifestation of self-interference, this interference pattern is observable despite the fact that the constituent light of the optical beam 202 may be incoherent. The spatial frequency of interference fringes in the interference pattern depends on the wavelength of light and further depends on the wavefront curvature of the optical beam 202. Accordingly, a Fourier transform applied to the fringe pattern can be used to remap the detected fluorescence signal distribution to the depth of the fluorophore in the sample from which the fluorescence light originated.

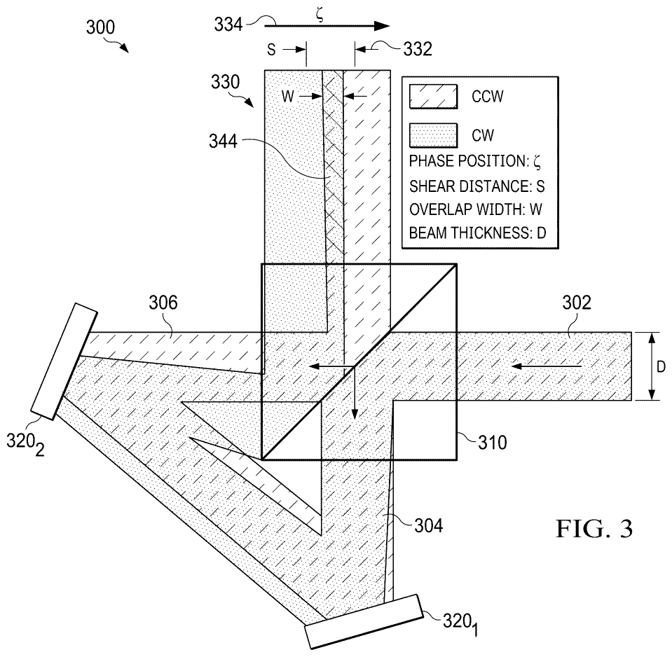

FIG. 3 is a schematic diagram illustrating a Sagnac interferometer 300 configured to generate sheared optical beams according to some examples. The interferometer 300 includes a beamsplitter 310 and mirrors 320₁, 320₂ arranged as indicated in FIG. 3. In some examples, the beamsplitter 310 is a 50:50 beamsplitter.

The beamsplitter 310 operates to split an input optical beam 302 into first and second attenuated beam copies 304 and 306. The first beam copy 304 traverses the interferometer 300 in the clockwise (CW) direction. The second beam copy 306 similarly traverses the interferometer 300 in the counterclockwise (CCW) direction. At an optical output port 330 of the interferometer 300, the first and second beam copies 304 and 306 are laterally offset by a shear distance 332 (denoted as s) and are partially overlayed in an overlap portion 334. The width of the overlap portion 334 is denoted as w. Both of the beam copies 304 and 306 maintain substantially the same initial diameter, which depends on the working aperture of the corresponding optical system. Both the width w and the shear distance s can be adjusted by changing the tilt angles of the mirrors 320₁, 320₂ with respect to the facets of the beamsplitter 310. A corresponding interference pattern can be observed at the optical output port 330 as a function of the position (denoted as ζ) along the shear direction indicated by an arrow 334.

In some examples, SIFT frames can be generated using self-interference of the collected fluorescence wavefronts, e.g., as illustrated in FIGS. 1-3. The intensity pattern (i_{d}) in the SIFT frames encodes depth information as spatial frequencies across both the shearing (ζ) and spectral (k) axes, with an interference envelope defined by the beam overlap (w) in the shear direction 334. The corresponding mathematical expression is as follows:

$${i}_{d} ( ζ , k ) = Rect ( \frac{ζ}{w} ) \cdot {\sum }_{n = 1}^{N} {I}_{n} \cdot cos ( ζ \frac{{ksz}_{n}}{{M}^{2} {f}_{obj}^{2}} ) \qquad ( 1 )$$

where Iₙ is the intensity from the n-th fluorescent emitter; f_{obj} is the focal length of the objective lens; M is the total magnification of the detection system; s is the shear introduced by the interferometer; and zₙ is the depth of the n-th fluorescent emitter.

The interference pattern (i_{d}) can be transformed into the shearing spatial frequency domain, producing a series of peaks that can be modeled using the following mathematical expression:

$${I}_{d} ( {f}_{z} , k ) = sinc ( {f}_{z} w ) * {\sum }_{n = 1}^{N} \frac{{I}_{n}}{2} δ ( {f}_{z} \pm \frac{{sz}_{n}}{λ {M}^{2} {f}_{obj}^{2}} ) \qquad ( 2 )$$

Mapping the spatial frequency (f_{z}) to the physical depth (z) yields the following relationship:

$$z = \frac{{M}^{2} {f}_{obj}^{2} λ}{s} \cdot {f}_{z} \qquad ( 3 )$$

where λ is the wavelength of light. Applying the remapping in accordance with Eq. (3) allows us to obtain real distance scaled spectral depth frames from the raw camera capture(s).

Axial resolution is determined by the finite width of the interference envelope. Using the full width at half-maximum (FWHM) of the normalized sinc function, one can estimate the frequency resolution (δz) as follows:

$$δ z = FWHM ( sinc ( \frac{z s}{{M}^{2} {f}^{2} λ} \cdot w ) ) = \frac{0.886 {M}^{2} {f}_{obj}^{2} λ}{sw} \qquad ( 4 )$$

Understanding that the sum of the shear distance and overlap width between the sheared beams is defined by the magnified collected aperture allows one to optimize the system resolution by maximizing their product expressed as follows:

$${( s \cdot w )}_{max} = \frac{{( M \cdot D )}^{2}}{4} \qquad ( 5 )$$

where D is the collected aperture of the system. Substituting this optimal value into Eq. (4) yields the following theoretical expression for the optimized axial resolution:

$$δ z = \frac{0.886 \cdot 4 λ {f}_{obj}^{2}}{{D}^{2}} \qquad ( 6 )$$

The righthand side of Eq. (6) can further be simplified into 3.544/(f #)².

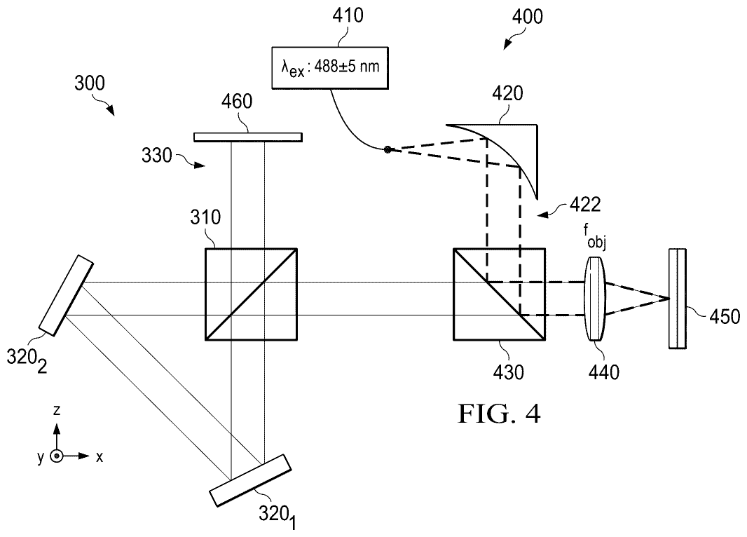

FIG. 4 is a schematic diagram illustrating an optical system 400 used for SIFT measurements according to some examples. The system 400 includes the above-described Sagnac interferometer 300 (FIG. 3). The system 400 also includes a 2D pixelated light detector (e.g., a CCD) 460 placed at the optical port 330 of the interferometer 300 (also see FIG. 3). In alternative embodiments, the optical system 400 may be implemented using a different (from Sagnac) interferometer suitable for generating sheared optical beams.

Excitation light is generated using a fiber-coupled light source (e.g., a laser) 410. In the example shown, the light source 410 is configured to operate at the output wavelength of 488 nm. In other examples, other excitation wavelengths (λₑₓ) can also be used. A collimator 420 is configured to collimate the diverging optical beam outputted by the fiber-coupled light source 410 and direct a resulting collimated optical beam 422 to a long pass (e.g., dichroic) optical filter 430. The optical characteristics of the optical filter 430 are such that the optical beam 422 is reflected thereby towards an objective lens 440 whereas the florescence light collected from a sample 450 by the objective lens 440 is transmitted therethrough towards the beamsplitter 310 of the interferometer 300. The interference of the corresponding sheared optical beams produced by the interferometer 300 is then detected by the light detector 460.

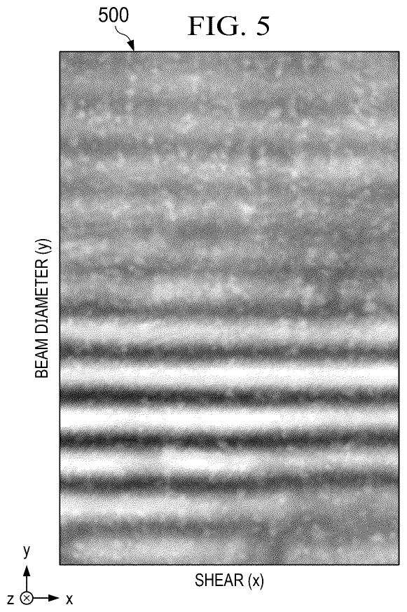

FIG. 5 pictorially illustrates an interference pattern 500 captured by the light detector 460 in the optical system 400 according to an example. Note that the XYZ coordinate triad shown in FIG. 5 is the same as that shown in FIG. 4. As described previously, when detected in the XY plane after the shear, the emissions from the fluorescent sample 450 generate interference patterns (of which the interference pattern 500 is an example) whose frequency content in the shear direction maps to the depth content of the sample, with the displayed color channels representing the spectral content of the emissions.

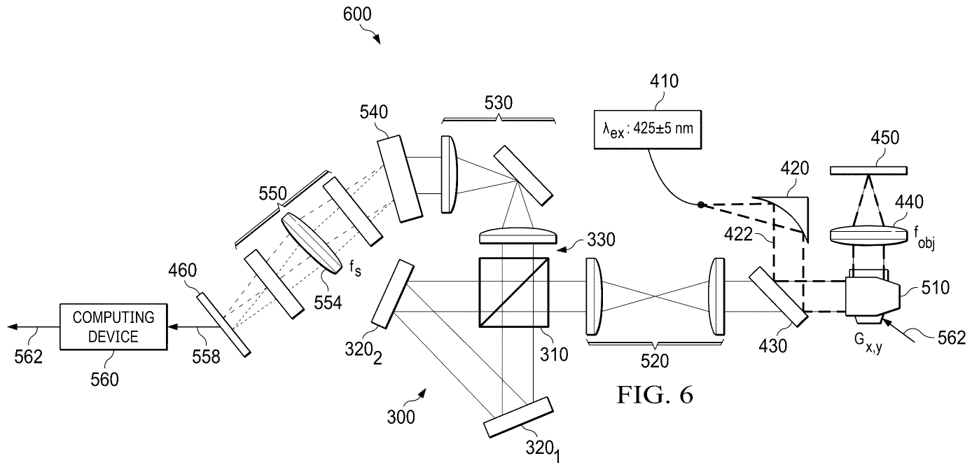

FIG. 6 is a schematic diagram illustrating an optical system 600 used for SIFT measurements according to some additional examples. Optical system 600 represents a modification of the optical system 400 (FIG. 4) and, as such, reuses various components of the latter system. The reused components are labeled in FIG. 6 using the same reference labels as in FIG. 4. For the description of those elements the reader is referred to the foregoing description of FIG. 4. The description of FIG. 6 provided below primarily focuses on the additional elements used to accomplish the modification of the optical system 400 that transform the latter into the optical system 600.

The additional elements used in the optical system 600 include an optical scanner (e.g., a 2-axis galvanometer pair, G_{xy}) 510, a first optical relay 520, a second optical relay 530, a diffraction grating 540, a third optical relay 550, a cylindrical lens (fₛ) 554, and a computing device 560. In some examples, the optical scanner 510 is configured to raster scan the fluorescence excitation beam 422 and de-scan the fluorescence emission light. In various additional examples, the optical scanner 510 can be driven to scan the optical beam 422 along any selected trajectory across the sample 450. The optical relays 520, 530, 550 provide selected magnification and/or demagnification and enable incorporation of the diffraction grating 540 and the cylindrical lens 554 into the pertinent optical paths. The grating 540 is configured to spectrally disperse the light received, via the optical relay 530, from the optical output port 330 of the interferometer 300. The cylindrical lens 554 is configured to focus the spectrally dispersed light on the 2D pixelated light detector 460. The computing device 560 is configured to process an electrical readout signal 558 received from the 2D pixelated light detector 460, e.g., as described in more detail below. The computing device 560 is further configured to generate a control signal 562 used to drive the optical scanner 510 such that the optical beam 422 follows the selected trajectory across the sample 450.

In the example shown, the fluorescence excitation beam 422 is generated with the light source 410 comprising a SuperK supercontinuum laser filtered through a SuperK SELECT tunable multi-channel acousto-optic tunable filter (AOTF) spectrally centered at 425 nm. Fluorescence excitation and emission are separated across the 490 nm long pass filter 430. The Thorlabs Steinheil Achromatic Triplet f_{obj} with a working NA of 0.09 is used to implement the objective lens 440. In some examples, the sample 450 includes an approximately 0.4 mm thick fluorescent phantom oriented at a 45° angle relative to the focal plane. In other examples, other samples are similarly imaged. The emission Fourier plane is magnified by the 3.125×4 f relay 520 to the interferometer 300. The interferometric output is demagnified by the 0.4×4 f relay 530. The Fourier-plane conjugate is imaged onto the 1200 l/mm volume holographic phase grating 540. The fluorescence spectra are focused onto the 2D CMOS (FLIR Blackfly S USB3) detector 460 for detection via a 100 mm objective lens. The shear interference is imaged onto the same detector 460 using the 1×4 f cylindrical-lens relay 550. The interferometer mirrors 320₁, 320₂ are tuned to achieve the selected beam offset s with no observable pathlength difference at the center of the detector 460. In some examples, the detector 460 has the size of 3648×5456 pixel² (8.8×13.1 mm²) in the shear (ζ) and spectral (λ) directions.

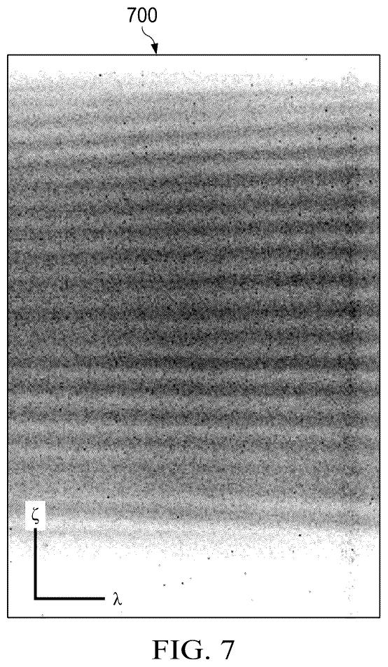

FIG. 7 pictorially illustrates a 2D frame 700 captured by the detector 460 in the optical system 600 according to an example. The frame 700 corresponds to a single point (pixel, position) along the scan trajectory across the sample 450. The two dimensions of the frame 700 are along the shear (ζ) and spectral (λ) directions, as indicated in FIG. 7.

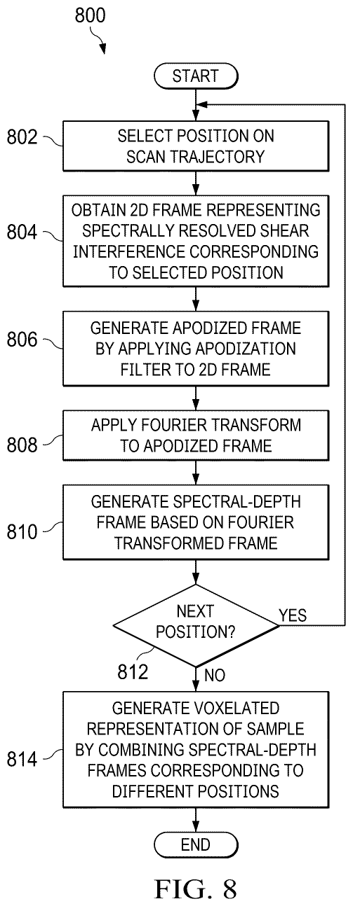

FIG. 8 is a flowchart illustrating a data-processing method 800 used in the optical system 600 according to some examples. The method 800 is executed by the computing device 560 in response to a sequence of 2D frames received from the detector 460 via the readout signal 558, with each of the 2D frames being analogous to the frame 700 (FIG. 7) and corresponding to a different respective position along the scan trajectory of the fluorescence excitation beam across the sample 450. When the scan trajectory implements a raster scan, the output of the method 800 can be used to construct a voxelated representation of the sample 450, wherein, for each voxel (i, j, k) corresponding to the spatial coordinate (xᵢ, yⱼ, zₖ) within the volume of the sample, the voxelated representation contains the corresponding fluorescence spectrum I_{i,j,k}(λ), where i, j, k are spatial indices. In some examples, the voxelated representation is a tesseract representation. In some examples, the voxelated representation is converted into a volumetric image by converting each fluorescence spectrum I_{i,j,k}(λ) (which is a vector value) into a luminosity value (which is a scalar) or into a color triplet, such as an RGB triplet. Conversion of a fluorescence spectrum into the corresponding luminosity value can be achieved, e.g., by integration along the wavelength dimension. Conversion of a fluorescence spectrum into a color triplet can be performed using any suitable conventional conversion algorithm configured to output a color triplet representing a true color or a pseudo color.

A block 802 of the method 800 includes selecting a position (xᵢ, yⱼ) on the scan trajectory. In some examples, the selected positions corresponding to different instances of the block 802 may represent consecutive dwell points (pixels) of the raster scan for which the respective 2D frames 700 have been captured. In various additional examples, the different positions (xᵢ, yⱼ) can be selected in any suitable order.

A block 804 of the method 800 includes obtaining the 2D frame 700 corresponding to the position (xᵢ, yⱼ) selected in the block 802. As indicated above, the 2D frame 700 represents spectrally resolved shear interference corresponding to the excitation configuration in which the focused excitation beam 422 hits the sample 450 at the point having the coordinates (xᵢ, yⱼ) in the focal plane of the objective 440. In various examples, the 2D frame 700 can be acquired in real time or be fetched from the memory in which the scan data were saved during runtime.

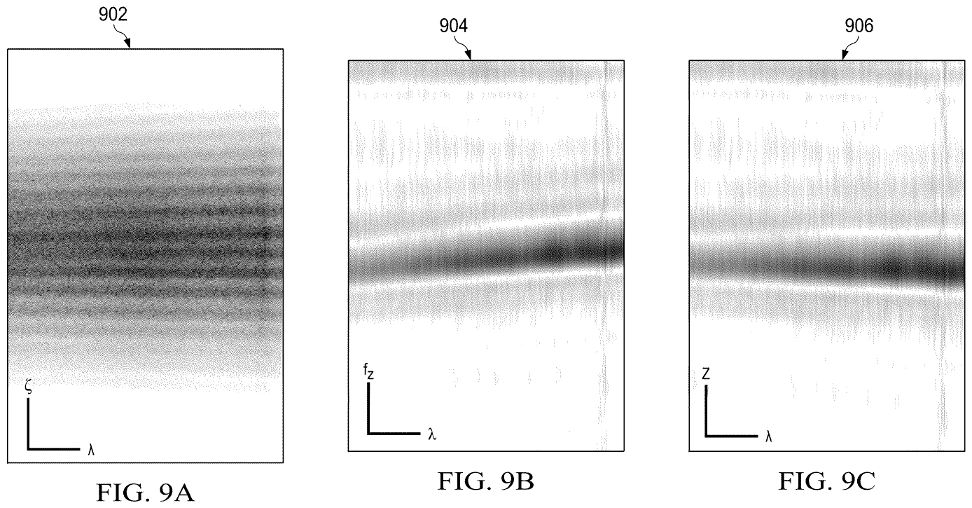

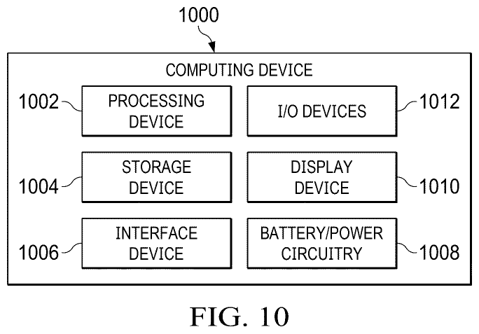

A block 806 of the method 800 includes applying apodization in the shear direction (ζ) to the 2D frame 700 obtained in the block 804. In some examples, the corresponding apodization filter is a Gaussian filter. In other examples, other suitable apodization filters can similarly be used. An example apodized frame generated in the block 806 is illustrated in FIG. 9A.

A block 808 of the method 800 includes applying a Fourier transform along the shear direction (ζ) of the apodized frame generated in the block 806. This Fourier transform results in a Fourier-transformed frame whose orthogonal axes are the spatial frequency f_{z} and the wavelength λ. In some examples, operations of the block 808 also include selecting a positive-frequency portion of the Fourier-transformed frame for further processing and discarding the negative-frequency portion of the Fourier-transformed frame. An example positive-frequency portion of the Fourier-transformed frame obtained in the block 808 is illustrated in FIG. 9B.

A block 810 of the method 800 includes converting the positive-frequency portion of the Fourier-transformed frame obtained in the block 808 into a spectral-depth frame whose orthogonal axes are the depth z and the wavelength λ. In some examples, the conversion of the spatial frequency f_{z} into the depth z is performed in accordance with Eq. (3). Operations of the block 810 may also include linearly resampling the spectral-depth frame to create constant-size (uniform) pixels in the z dimension. Operations of the block 810 may also include applying a wavelength-dependent shift (dispersion correction) to the columns of pixels of the spectral-depth frame to substantially minimize the spectral spread in the z dimension. An example spectral-depth frame obtained in the block 810 is illustrated in FIG. 9C.

A decision block 812 of the method 800 includes determining whether or not a next position (xᵢ, yⱼ) on the scan trajectory should be selected. When a next position is to be selected (“Yes” at the decision block 812), the processing of the method 800 is looped back to the block 802. Otherwise (“No” at the decision block 812), the processing of the method 800 is directed to a block 814.

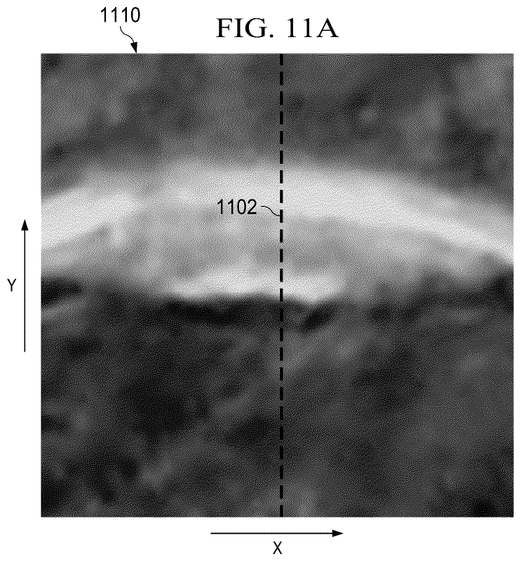

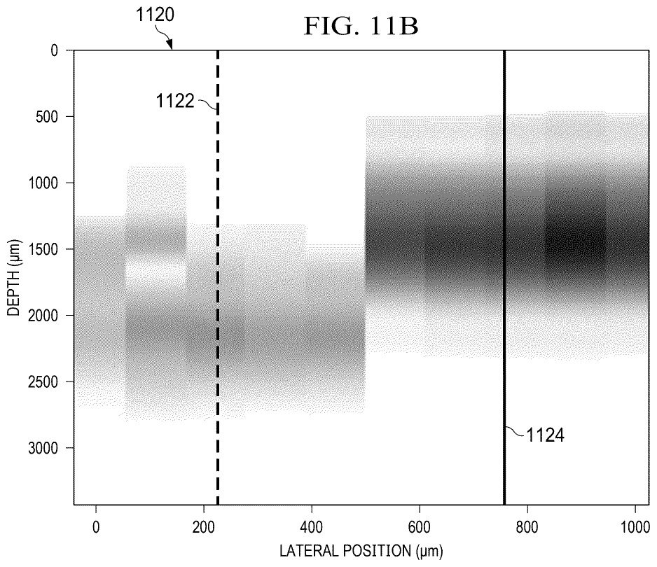

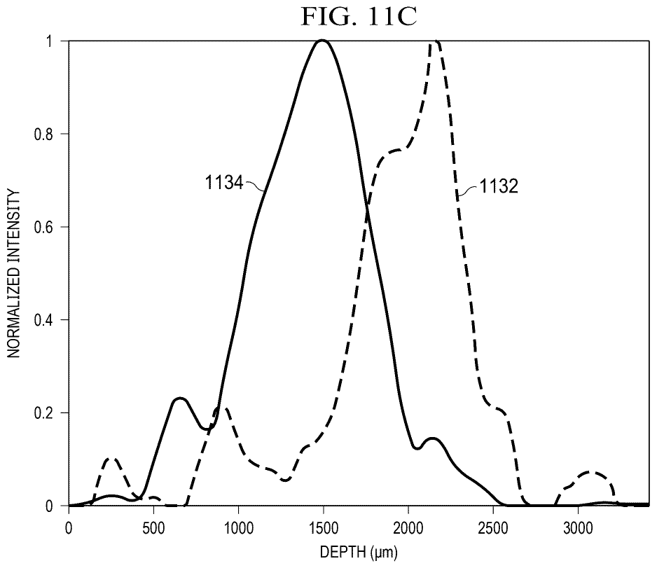

Operations of the block 814 include generating a voxelated representation of the sample 450 by combining the spectral-depth frames corresponding to different positions (xᵢ, yⱼ). As indicated above, the voxelated representation of the sample 450 includes the corresponding fluorescence spectrum I_{i,j,k}(λ) for each voxel (i, j, k) corresponding to the spatial coordinate (xᵢ, yⱼ, zₖ) within the volume of the sample. A person of ordinary skill in the pertinent art will readily understand that the voxelated representation generated in the block 814 lends itself to convenient post-processing and analysis for determining certain volumetric characteristics of the sample 450. Examples of such postprocessing include, but are not limited to, converting the voxelated representation into a monochrome or color volumetric image (as indicated above) and obtaining various planar cross-sections of the volumetric image for observation and/or further analysis. Additional examples of post-processing are illustrated in FIGS. 11A-11C.

FIGS. 9A-9C pictorially illustrate 2D frames 902, 904, 906 generated during execution of the method 800 according to some examples. More specifically, each of the frames 902, 904, 906 corresponds to the frame 700 shown in FIG. 7, which represents a 2D frame obtained in the block 804 of the method 800. The frame 902 (FIG. 9A) is the apodized frame generated in the block 806 of the method 800 based on the frame 700. The frame 904 (FIG. 9B) is the positive-frequency portion of the Fourier-transformed frame obtained in the block 808 of the method 800 based on the apodized frame 902. The frame 906 (FIG. 9C) is the spectral-depth frame obtained in the block 810 of the method 800 based on the Fourier-transformed frame 904.

FIG. 10 is a block diagram illustrating a computing device 1000 one or more instance of which are used in or in conjunction with the optical system 600 according to some examples. In some examples, the computing device 1000 implements the computing device 560 (FIG. 6) and/or an electronic controller connected to the optical system 600.

The computing device 1000 of FIG. 10 is illustrated as having a number of components, but any one or more of these components may be omitted or duplicated, as suitable for the application and setting. In some embodiments, some or all of the components included in the computing device 1000 may be attached to one or more motherboards and enclosed in a housing. In some embodiments, some of those components may be fabricated onto a single system-on-a-chip (SoC) (e.g., the SoC may include one or more electronic processing devices 1002 and one or more storage devices 1004). Additionally, in various embodiments, the computing device 1000 may not include one or more of the components illustrated in FIG. 10, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 1000 may not include a display device 1010, but may include display device interface circuitry (e.g., a connector and driver circuitry) to which an external display device 1010 may be coupled.

The computing device 1000 includes a processing device 1002 (e.g., one or more processing devices). As used herein, the terms “electronic processor device” and “processing device” interchangeably refer to any device or portion of a device that processes electronic data from registers and/or memory to transform that electronic data into other electronic data that may be stored in registers and/or memory. In various embodiments, the processing device 1002 may include one or more digital signal processors (DSPs), application-specific integrated circuits (ASICs), central processing units (CPUs), graphics processing units (GPUs), server processors, or any other suitable processing devices.

The computing device 1000 also includes a storage device 1004 (e.g., one or more storage devices). In various embodiments, the storage device 1004 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 1004 may include memory that shares a die with the processing device 1002. In such an embodiment, the memory may be used as cache memory and include embedded dynamic random-access memory (eDRAM) or spin transfer torque magnetic random-access memory (STT-MRAM), for example. In some embodiments, the storage device 1004 may include non-transitory computer readable media having instructions thereon that, when executed by one or more processing devices (e.g., the processing device 1002), cause the computing device 1000 to perform any appropriate ones of the methods disclosed herein below or portions of such methods.

The computing device 1000 further includes an interface device 1006 (e.g., one or more interface devices 1006). In various embodiments, the interface device 1006 may include one or more communication chips, connectors, and/or other hardware and software to govern communications between the computing device 1000 and other computing devices. For example, the interface device 1006 may include circuitry for managing wireless communications for the transfer of data to and from the computing device 1000. The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 1006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device 1006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 1006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 1006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 1006 may include one or more antennas (e.g., one or more antenna arrays) configured to receive and/or transmit wireless signals.

In some embodiments, the interface device 1006 may include circuitry for managing wired communications, such as electrical, optical, or any other suitable communication protocols. For example, the interface device 1006 may include circuitry to support communications in accordance with Ethernet technologies. In some embodiments, the interface device 1006 may support both wireless and wired communication, and/or may support multiple wired communication protocols and/or multiple wireless communication protocols. For example, a first set of circuitry of the interface device 1006 may be dedicated to shorter-range wireless communications such as Wi-Fi or Bluetooth, and a second set of circuitry of the interface device 1006 may be dedicated to longer-range wireless communications such as global positioning system (GPS), EDGE, GPRS, CDMA, WiMAX, LTE, EV-DO, or others. In some other embodiments, a first set of circuitry of the interface device 1006 may be dedicated to wireless communications, and a second set of circuitry of the interface device 1006 may be dedicated to wired communications.

The computing device 1000 also includes battery/power circuitry 1008. In various embodiments, the battery/power circuitry 1008 may include one or more energy storage devices (e.g., batteries or capacitors) and/or circuitry for coupling components of the computing device 1000 to an energy source separate from the computing device 1000 (e.g., to AC line power).

The computing device 1000 also includes a display device 1010 (e.g., one or multiple individual display devices). In various embodiments, the display device 1010 may include any visual indicators, such as a heads-up display, a computer monitor, a projector, a touchscreen display, a liquid crystal display (LCD), a light-emitting diode display, or a flat panel display.

The computing device 1000 also includes additional input/output (I/O) devices 1012. In various embodiments, the I/O devices 1012 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment, various components of the interface devices 1006 and/or I/O devices 1012 can be configured to output suitable control signals, receive suitable control/telemetry signals, and receive and transmit data streams. In some examples, the interface devices 1006 and/or I/O devices 1012 include one or more analog-to-digital converters (ADCs) for transforming received analog signals into a digital form suitable for operations performed by the processing device 1002 and/or the storage device 1004. In some additional examples, the interface devices 1006 and/or I/O devices 1012 include one or more digital-to-analog converters (DACs) for transforming digital signals provided by the processing device 1002 and/or the storage device 1004 into an analog form suitable for being transmitted through a communication channel.

FIGS. 11A-11C pictorially and graphically illustrate volumetric imaging results obtained with the optical system 600 according to an example. In the example shown, the sample 450 includes a two-layer 3D phantom. The two fluorescent layers of the phantom are separated axially by a 220 μm-thick glass coverslip. The first fluorescent layer is a 220 μm-thick layer of a fluorescent orange dye on top of the coverslip, covering one half of the lateral extent. The second fluorescent layer is a 220 μm-thick layer of a fluorescent green dye beneath the coverslip.

FIG. 11A is a photograph 1110 of the two-layer phantom enlarged and color-enhanced for clarity. A dashed line 1102 indicates the imaging scan path (trajectory), which is approximately 1 mm long in the Y direction.

FIG. 11B is a pixelated image 1120 illustrating the cross-section of the imaged two-layer phantom along the scan path 1102. In the data processing, we selected a spectral band around the center wavelength of each fluorescent dye for spectral averaging. These averaged bands were then mapped to the yellow and green channels with Image-J to convert the dataset into a pseudo-color, spectrally averaged depth section illustrated by the image 1120.

FIG. 11C graphically illustrates chromatically filtered intensity depth profiles 1132 and 1134 obtained from the image 1120. The intensity depth profile 1132 corresponds to a first lateral position, which is marked in FIG. 11B by a dashed line 1122. The intensity depth profile 1134 corresponds to a different second lateral position, which is marked in FIG. 11B by a dashed line 1124.

According to an example embodiment disclosed above, e.g., in the summary section and/or in reference to any one or any combination of some or all of FIGS. 1-11, provided is a volumetric imaging apparatus comprising: optics configured to collect fluorescence light emitted from a sample in response to an excitation optical beam; an interferometer configured to split the fluorescence light collected by the optics into a first light portion and a second light portion and further configured to recombine the first and second light portions with a shear therebetween; a grating configured to spectrally disperse the recombined light in wavelengths; and a detector configured to capture the spectrally dispersed recombined light in a two-dimensional (2D) pixelated frame in which a first dimension represents the wavelengths and an orthogonal second dimension represents the shear.

In some embodiments of the above apparatus, the apparatus further comprises a computing device configured to: receive from the detector a readout signal representing the 2D pixelated frame; and obtain a depth profile of the fluorescence light in the sample based on the readout signal.

In some embodiments of any of the above apparatus, the computing device is configured to obtain the depth profile using a Fourier transform applied to the orthogonal second dimension of the 2D pixelated frame.

In some embodiments of any of the above apparatus, the apparatus further comprises an optical scanner configured to scan the excitation optical beam along a trajectory across the sample in response to a control signal received from the computing device.

In some embodiments of any of the above apparatus, the computing device is further configured to generate a fluorescence-based volumetric image of the sample based on a plurality of depth profiles obtained from a plurality of 2D pixelated frames in which each one of the 2D pixelated frames corresponds to a different respective position of the excitation optical beam along the trajectory.

In some embodiments of any of the above apparatus, the trajectory is configured to implement a raster scan of the sample.

In some embodiments of any of the above apparatus, the apparatus further comprises an optical scanner configured to scan the excitation optical beam along a trajectory across the sample.

In some embodiments of any of the above apparatus, the optics comprises an objective lens optically coupled between the optical scanner and the sample.

In some embodiments of any of the above apparatus, the optics comprises a dichroic filter optically coupled between the optical scanner and the interferometer.

In some embodiments of any of the above apparatus, the optics further comprises: a first optical relay optically coupled between the dichroic filter and the interferometer; and a second optical relay optically coupled between the interferometer and the grating.

In some embodiments of any of the above apparatus, the first optical relay is a magnifying optical relay; and wherein the second optical relay is a demagnifying optical relay.

In some embodiments of any of the above apparatus, the optics further comprises a third optical relay optically coupled between the grating and the detector.

In some embodiments of any of the above apparatus, the third optical relay includes a cylindrical lens configured to focus the spectrally dispersed recombined light in the first dimension.

In some embodiments of any of the above apparatus, the interferometer includes a Sagnac interferometer.

In some embodiments of any of the above apparatus, the interferometer comprises: a beamsplitter; a first mirror optically coupled to the beamsplitter; and a second mirror optically coupled to the beamsplitter and the first mirror, wherein the beamsplitter causes the first light portion travel through the interferometer in a clockwise direction and further causes the second light portion travel through the interferometer in a counterclockwise direction.

In some embodiments of any of the above apparatus, respective tilt angles of the first and second mirrors with respect to the beamsplitter are adjustable to regulate a shear distance.

According to another example embodiment disclosed above, e.g., in the summary section and/or in reference to any one or any combination of some or all of FIGS. 1-11, provided is a volumetric imaging method comprising: acquiring a plurality of two-dimensional (2D) pixelated frames representing self-interference of fluorescence light emitted from a sample in response to an excitation optical beam being scanned along a trajectory across the sample, with each one of the 2D pixelated frames corresponding to a different respective position of the excitation optical beam along the trajectory; based on each one of the 2D pixelated frames, obtaining a respective depth profile of the fluorescence light in the sample; and generating a volumetric image of the sample based on the respective depth profiles and further based on the trajectory, wherein a first dimension in the 2D pixelated frames represents wavelengths of the fluorescence light; and wherein an orthogonal second dimension in the 2D pixelated frames represents a shear used to produce the self-interference of the fluorescence light.

In some embodiments of the above method, the obtaining comprises: applying an apodization filter to the second dimension of a frame; applying a Fourier transform to the second dimension of the apodization-filtered frame to generate a spatial-frequency frame; resampling the spatial-frequency frame; and converting the resampled spatial frequency frame into a corresponding spectral-depth frame.

In some embodiments of any of the above methods, the generating comprises combining a plurality of spectral-depth frames corresponding to the different respective positions of the excitation optical beam along the trajectory.

According to yet another example embodiment, provided is a non-transitory computer-readable medium storing instructions that, when executed by an electronic processor, cause the electronic processor to perform operations comprising any one of the above methods.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Any numerical range recited herein includes all values from the lower value to the upper value. For example, if a range is stated as 1% to 50%, it is intended that the narrower ranges thereof, such as 2% to 40%, 10% to 30%, 1% to 3%, etc., are expressly enumerated by said statement. These specific examples represent only a limited subset of what is intended to be covered, and all possible combinations of numerical values between and including the lowest value and the highest value of the enumerated range are to be considered to be expressly stated in this application. Concentration ranges, pH ranges, and other ranges of specific parameters are intended to be interpreted in a manner similar to the “%” example.

The modifier “about” or “approximately” used in connection with a quantity is inclusive of the stated value and has the meaning dictated by the context (for example, it includes at least the degree of error associated with the measurement of the particular quantity). The modifier “about” or “approximately” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so that, for example, “about 1” may also mean from 0.5 to 1.4.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

What is claimed is:

1. An imaging apparatus, comprising:
optics configured to collect fluorescence light emitted from a sample in response to an excitation optical beam;
an interferometer configured to split the fluorescence light collected by the optics into a first light portion and a second light portion and further configured to recombine the first and second light portions with a shear therebetween;
a grating configured to spectrally disperse the recombined light in wavelengths; and
a detector configured to capture the spectrally dispersed recombined light in a two-dimensional (2D) frame in which a first dimension represents the wavelengths and an orthogonal second dimension represents the shear.

2. The apparatus of claim 1, further comprising a computing device configured to:
receive from the detector a readout signal representing the 2D frame; and
obtain a depth profile of the fluorescence light in the sample based on the readout signal.

3. The apparatus of claim 2, wherein the computing device is configured to obtain the depth profile using a Fourier transform applied to the orthogonal second dimension of the 2D frame.

4. The apparatus of claim 2, further comprising an optical scanner configured to scan the excitation optical beam along a trajectory across the sample in response to a control signal received from the computing device.

5. The apparatus of claim 4, wherein the computing device is further configured to generate a fluorescence-based volumetric image of the sample based on a plurality of depth profiles obtained from a plurality of 2D frames in which each one of the 2D frames corresponds to a different respective position of the excitation optical beam along the trajectory.

6. The apparatus of claim 4, wherein the trajectory is configured to implement a raster scan of the sample.

7. The apparatus of claim 1, further comprising an optical scanner configured to scan the excitation optical beam along a trajectory across the sample.

8. The apparatus of claim 7, wherein the optics comprises an objective lens optically coupled between the optical scanner and the sample.

9. The apparatus of claim 7, wherein the optics comprises a dichroic filter optically coupled between the optical scanner and the interferometer.

10. The apparatus of claim 9, wherein the optics further comprises:
a first optical relay optically coupled between the dichroic filter and the interferometer; and
a second optical relay optically coupled between the interferometer and the grating.

11. The apparatus of claim 10,
wherein the first optical relay is a magnifying optical relay; and
wherein the second optical relay is a demagnifying optical relay.

12. The apparatus of claim 10, wherein the optics further comprises a third optical relay optically coupled between the grating and the detector.

13. The apparatus of claim 12, wherein the third optical relay includes a cylindrical lens configured to focus the spectrally dispersed recombined light in the first dimension.

14. The apparatus of claim 1, wherein the interferometer includes a Sagnac interferometer.

15. The apparatus of claim 1, wherein the interferometer comprises:
a beamsplitter;
a first mirror optically coupled to the beamsplitter; and
a second mirror optically coupled to the beamsplitter and the first mirror,
wherein the beamsplitter causes the first light portion travel through the interferometer in a clockwise direction and further causes the second light portion travel through the interferometer in a counterclockwise direction.

16. The apparatus of claim 15, wherein respective tilt angles of the first and second mirrors with respect to the beamsplitter are adjustable to regulate a shear distance.

17. An imaging method, comprising:
acquiring a plurality of two-dimensional (2D) frames representing self-interference of fluorescence light emitted from a sample in response to an excitation optical beam being scanned along a trajectory across the sample, with each one of the 2D frames corresponding to a different respective position of the excitation optical beam along the trajectory;
based on each one of the 2D frames, obtaining a respective depth profile of the fluorescence light in the sample; and
generating a volumetric image of the sample based on the respective depth profiles and further based on the trajectory,
wherein a first dimension in the 2D frames represents wavelengths of the fluorescence light; and
wherein an orthogonal second dimension in the 2D frames represents a shear used to produce the self-interference of the fluorescence light.

18. The method of claim 17, wherein the obtaining comprises:
applying an apodization filter to the second dimension of a 2D frame;
applying a Fourier transform to the second dimension of the apodization-filtered frame to generate a spatial-frequency frame;
resampling the spatial-frequency frame; and
converting the resampled spatial frequency frame into a corresponding spectral-depth frame.

19. The method of claim 18, wherein the generating comprises combining a plurality of spectral-depth frames corresponding to the different respective positions of the excitation optical beam along the trajectory.

20. A non-transitory computer-readable medium storing instructions that, when executed by an electronic processor, cause the electronic processor to perform operations comprising the method of claim 17.
